(19) United States
(12) Patent Application Publication
(10) Pub. No.: US 2020/0079181 A1
(43) Pub. Date: Mar. 12, 2020

(54) SIDE DEFROSTER DEVICE

(71) Applicant: HONDA MOTOR CO., LTD., Tokyo (JP)

(72) Inventors: Kentaro Sato, Wako-shi (JP); Yasuyuki Hoshi, Yamato-shi (JP)

(73) Assignee: HONDA MOTOR CO., LTD., Tokyo (JP)

(21) Appl. No.: 16/560,144

(22) Filed: Sep. 4, 2019

(30) Foreign Application Priority Data
Sep. 6, 2018 (JP) 2018-166782

(51) Int. Cl. B60H 1/24; B60S 1/02; B60H 1/34

(52) U.S. Cl. CPC B60H 1/243; B60H 1/00564; B60H 1/3407; B60S 1/023

(57) ABSTRACT

A side defroster device includes a front pillar that rises from a laterally outer end part of an instrument panel, and a defroster blower outlet that is provided in the front pillar and blows out air toward a side window screen. A display device that displays an image of a vehicle exterior is provided on the instrument panel to a rear of the front pillar. The defroster blower outlet is positioned so as to overlap, in a vehicle width direction, an upper wall of a housing when viewed in a fore-and-aft direction. Accordingly, air blown out from the defroster blower outlet diffuses on the upper wall of the housing, and part thereof flows toward the side window screen, thus enabling the side window screen to be demisted effectively.

### BACKGROUND OF THE INVENTION

### Field of the Invention

The present invention relates to a side defroster device comprising a front pillar that rises from a laterally outer end part of an instrument panel, and a defroster blower outlet that is provided in the front pillar and blows out air toward a side window screen.

### Description of the Related Art

Japanese Patent Application Laid-open No. 2016-124393 has made known an arrangement in which a camera facing toward the rear of a vehicle body is provided at a position where a door mirror of an automobile is provided, and an image taken toward the rear of the vehicle body by the camera is displayed on a display device provided on an instrument panel at the lower end of a front pillar.

When a defroster blower outlet of a side defroster device for blowing air onto a side window screen to thus demist it is provided on a front pillar, if a display device for displaying an image taken toward the rear of the vehicle body is provided at the lower end of the front pillar, the defroster blower outlet interferes with the display device, there is a possibility that it will become difficult to efficiently make air blown out from the defroster blower outlet impinge on the side window screen.

### SUMMARY OF THE INVENTION

The present invention has been accomplished in light of the above circumstances, and it is an object thereof to ensure the function of a defroster device having a defroster blower outlet in a front pillar when a display device is provided on an instrument panel to the rear of the front pillar.

In order to achieve the object, according to a first aspect of the present invention, there is provided a side defroster device comprising a front pillar that rises from a laterally outer end part of an instrument panel, and a defroster blower outlet that is provided in the front pillar and blows out air toward a side window screen, wherein a display device that displays an image of a vehicle exterior is provided on the instrument panel to a rear of the front pillar, and the defroster blower outlet is positioned so as to overlap, in a vehicle width direction, an upper wall of a housing when viewed in a fore-and-aft direction.

In accordance with the first aspect, the side defroster device includes the front pillar rising from the laterally outer end part of the instrument panel and the defroster blower outlet provided in the front pillar and blowing out air toward the side window screen. Since the display device displaying an image of the vehicle exterior is provided on the instrument panel to the rear of the front pillar, and the defroster blower outlet is at a position where it overlaps the upper wall of the housing in the vehicle width direction when viewed in the fore-and-aft direction, air blown out from the defroster blower outlet diffuses on the upper wall of the housing, and part thereof flows toward the side window screen, thus enabling the side window screen to be demisted effectively.

According to a second aspect of the present invention, in addition to the first aspect, the lower end of the defroster blower outlet is positioned so as to be in contact with the upper wall of the housing.

In accordance with the second aspect, since the lower end of the defroster blower outlet is at a position where it is in contact with the upper wall of the housing, air blown out from the defroster blower outlet is guided smoothly to the upper wall of the housing, thus enabling the side window screen to be demisted effectively.

According to a third aspect of the present invention, in addition to the first or second aspect, a side door is disposed on a laterally outer side of the instrument panel, the housing protrudes from the instrument panel to the laterally outer side, and a position in an up-down direction of an upper end of a door lining covering a laterally inner face of the side door is present between an upper end and a lower end of the housing.

In accordance with the third aspect, since the side door is disposed on the laterally outer side of the instrument panel, the housing protrudes outward in the vehicle width direction from the instrument panel, and the position in the up-down direction of the upper end of the door lining covering the laterally inner face of the side door is between the upper end and the lower end of the housing, part of the air diffused on the upper wall of the housing is guided smoothly to the space between the laterally outer wall of the housing and the door lining, thus enabling the lower front part of the side window screen to be demisted effectively.

According to a fourth aspect of the present invention, in addition to any one of the first to third aspects, a corner portion between the upper wall and a laterally outer wall of the housing has a rounded shape.

In accordance with the fourth aspect, since the corner portion between the upper wall and the laterally outer wall of the housing has a rounded shape, part of the air diffused on the upper wall of the housing is guided smoothly to the lower front part of the side window screen, thus enabling it to be demisted effectively.

Note that a first corner portion 21c of an embodiment corresponds to the corner portion of the present invention.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 is a view of an instrument panel when viewed from a driving seat of an automobile.

FIG. 2 is a view from arrowed line 2-2 in FIG. 1.

FIG. 3 is a sectional view along line 3-3 in FIG. 1.

FIG. 4 is a sectional view along line 4-4 in FIG. 1.

### DESCRIPTION OF THE PREFERRED EMBODIMENT

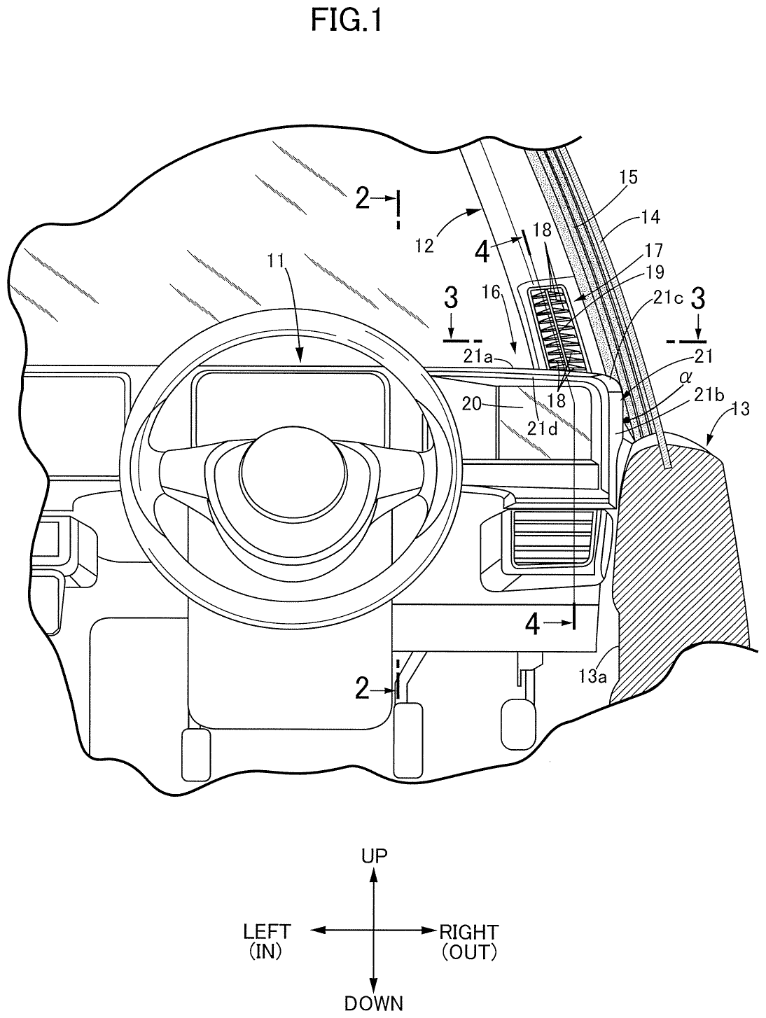

An embodiment of the present invention is explained below by reference to FIG. 1 to FIG. 4. In the following description reference numbers corresponding to components of the exemplary embodiment are included only for ease of understanding, but the applicant's claims are not limited to the exemplary embodiment or to specific components of the exemplary embodiment. In the present specification, the fore-and-aft direction, the left-and-right direction (vehicle width direction, lateral direction), and the up-and-down direction are defined with reference to an occupant seated on a driving seat.

As shown in FIG. 1, an instrument panel 11 extending in the vehicle width direction is disposed in front of a front seat of an automobile, and a front pillar 12 rises upward to the rear from the laterally outer end of the instrument panel 11. A side door 13, which is a sashless door disposed on the laterally outer side of the front seat, includes a side window screen 14, and the front edge of the side window screen 14 abuts against a seal member 15 provided on the front pillar 12. A camera, which is not illustrated, for taking an image toward the rear of the vehicle body is provided on a laterally outer face of the side door 13, and a display device 16 for displaying an image of the camera is provided at the laterally outer end of the instrument panel 11. The camera and the display device 16 form a CMS (camera monitor system) that replaces a conventional door mirror.

A side defroster device that blows warm air onto an inner face of the side window screen 14 to prevent misting includes a defroster blower outlet 17 opening on a rear face of a lower part of the front pillar 12. The defroster blower outlet 17, which extends lengthwise upward from the lower end of the front pillar 12, includes a plurality of horizontal fins 18 disposed in the vehicle width direction and one vertical fin 19 connecting the plurality of horizontal fins 18 in the up-down direction, and the horizontal fin 18 and the vertical fin 19 guide warm air so that it blows out in a predetermined direction.

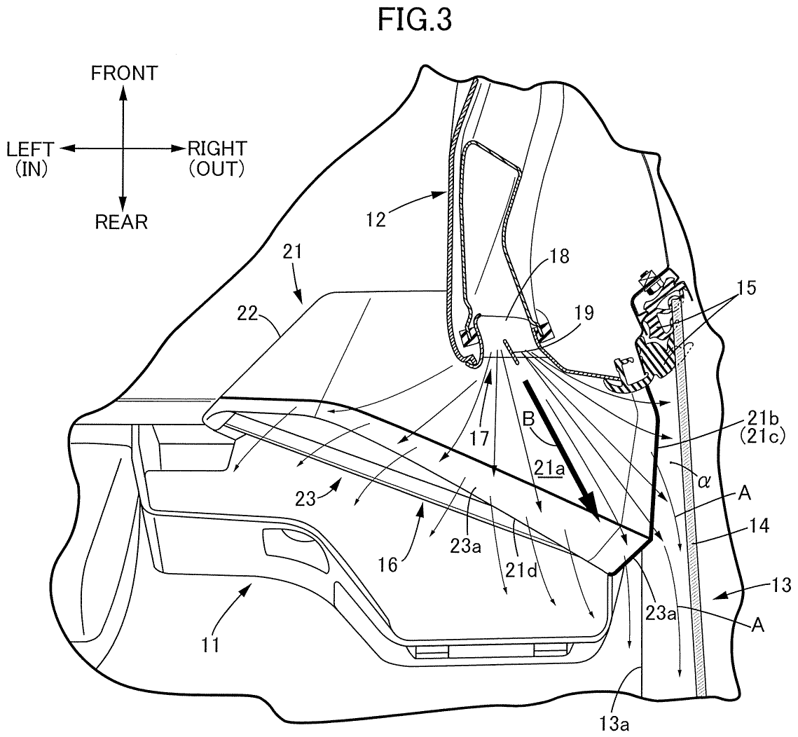

As shown in FIG. 1 to FIG. 3, the display device 16 includes a display 20 formed from a liquid crystal screen displaying an image, and a housing 21 encircling the display 20; the housing 21 is formed from a box-shaped front housing 22 positioned on the front side and supporting the display 20 via the rear end and a rectangular frame-shaped rear housing 23 joined to the rear end of the front housing 22 (see FIG. 3), and an occupant can see the display 20 through the rear housing 23.

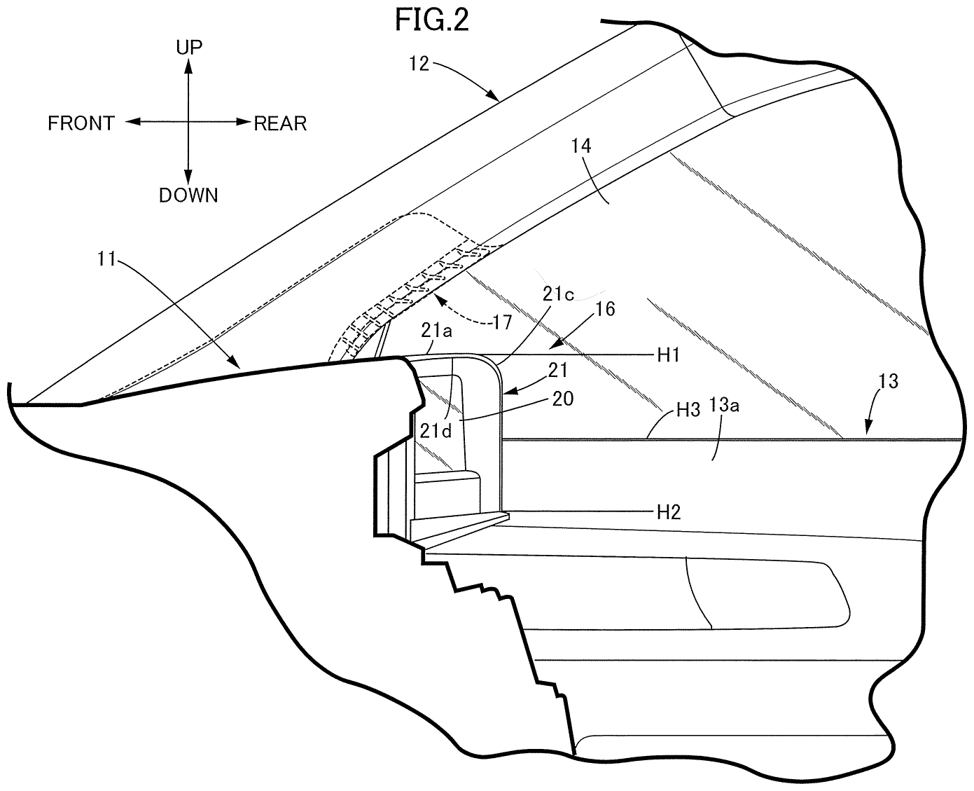

The housing 21 of the display device 16 has an upper wall 21a extending substantially horizontally; the lower end of the defroster blower outlet 17 is in contact with the front end of the upper wall 21a of the housing 21, and the defroster blower outlet 17 overlaps the upper wall 21a of the housing 21 when viewed in the fore-and-aft direction. The front housing 22 of the housing 21 of the display device 16 has an outer wall 21b protruding outward in the vehicle width direction from the laterally outer end of the instrument panel 11 and extending substantially vertically in the vehicle width direction, and the laterally outer wall 21b opposes a lower front part of the side window screen 14 of the side door 13 across a space a (see FIG. 1 and FIG. 3). A height H3 of the upper end of a door lining 13a is positioned between an upper end H1 and a lower end H2 of the laterally outer wall 21b of the housing 21 (see FIG. 2).

A first corner portion 21c extending in the fore-and-aft direction between the upper wall 21a and the laterally outer wall 21b of the housing 21 curves smoothly with a large radius of curvature, whereas a second corner portion 21d extending in the vehicle width direction at the rear edge of the upper wall 21a of the housing 21 curves strongly with a radius of curvature that is smaller than the radius of curvature of the first corner portion 21c. A rear part of the housing 21, that is, an outer peripheral face of the rear housing 23, forms an inclined face 23a that tapers so as to become narrower in going rearward (see FIG. 3).

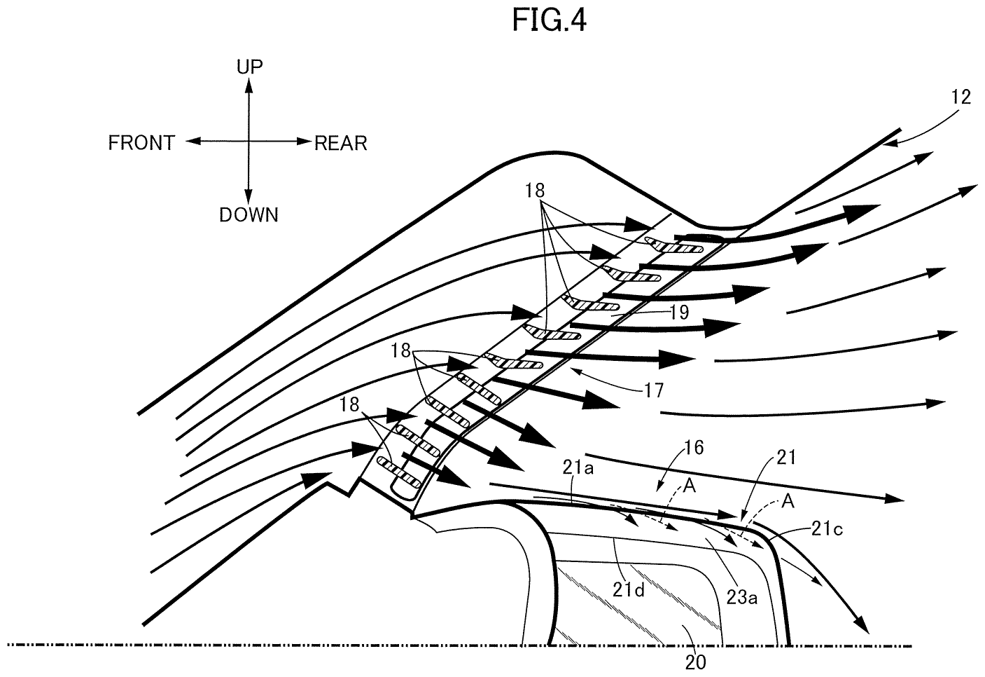

As shown in FIG. 4, the defroster blower outlet 17 opposes a lower half part of the side window screen 14, and among the plurality of horizontal fins 18 those positioned on the upper side are inclined so as to guide warm air horizontally or obliquely upward when viewed in the vehicle width direction, and among the plurality of horizontal fins 18 those positioned on the lower side are inclined so as to guide warm air obliquely downward when viewed in the vehicle width direction. Furthermore, as shown in FIG. 3, when viewed from above, the direction in which the vertical fin 19 of the defroster blower outlet 17 is directed (see arrow B) is inclined outward in the vehicle width direction and intersects the laterally outer wall 21b of the housing 21 of the display device 16 (see thick line in FIG. 3). More specifically, the direction in which the vertical fin 19 is directed intersects the inclined face 23a of the rear housing 23.

The operation of the embodiment of the present invention having the above arrangement is now explained.

When an inner face of the side window screen 14 of the side door 13 becomes misty, warm air is blown out rearward from the defroster blower outlet 17 of the front pillar 12, the warm air is guided in the horizontal direction or obliquely upward by, among the plurality of horizontal fins 18, the horizontal fins 18 on the upper side, and is guided obliquely downward by the horizontal fins 18 on the lower side, thus blowing it onto the entire region of the side window screen 14 and removing the misting. In this process, since the housing 21 of the display device 16 is present between the defroster blower outlet 17 and the lower front part of the side window screen 14, it is difficult for warm air to reach the lower front part of the side window screen 14 in particular due to the housing 21 interfering, and there is the problem that it is difficult to demist said part.

If the position of the housing 21 of the display device 16 is moved to the laterally inner side, warm air can be blown onto the lower front part of the side window screen 14 without interference from the housing 21, but since the display device 16 has the function of a conventional door mirror, if it is moved to the laterally inner side, it is moved away from the position of the conventional door mirror, and the driver will experience a disagreeable sensation.

However, in accordance with the present embodiment, since the defroster blower outlet 17 is positioned so as to overlap the upper wall 21a of the housing 21 in the vehicle width direction when viewed in the fore-and-aft direction, and part of the warm air is blown onto the upper wall 21a of the housing 21 of the display device 16 by means of the vertical fin 19 and the horizontal fin 18 provided in the defroster blower outlet 17, the warm air is diffused in the vehicle width direction on the upper wall 21a of the housing 21, and part hereof flows toward the side window screen 14, thus demisting the lower front part of the side window screen 14 effectively.

In particular, since the lower end of the defroster blower outlet 17 is positioned so as to be in contact with the upper wall 21a of the housing 21, and the vertical fin 19 of the defroster blower outlet 17 is directed toward the laterally outer wall 21b of the housing 21 when viewed from above (see arrow B in FIG. 3), warm air blown out from the defroster blower outlet 17 is guided to the upper wall 21a of the housing 21 without being wasted and flows downward through the space a between the laterally outer wall 21b of the housing 21 and the side window screen 14, thereby more effectively demisting the lower front part of the side window screen 14, which is hard for warm air to reach (see arrow A in FIG. 3 and FIG. 4).

In this process, since the laterally outer wall 21b of the housing 21 of the display device 16 protrudes outward in the vehicle width direction from the instrument panel 11, and the position H3 in the up-down direction of the upper end of the door lining 13a covering the laterally inner face of the side door 13 is positioned between the upper end H1 and the lower end H2 of the housing 21, not only can part of the warm air diffused by the upper wall 21a of the housing 21 be guided smoothly to the space a between the laterally outer wall 21b of the housing 21 and the door lining 13a, but it is also possible to smoothly deflect downward part of the warm air diffused on the upper wall 21a of the housing 21 and guide it smoothly to the lower front part of the side window screen 14 due to the first corner portion 21c between the upper wall 21a and the laterally outer wall 21b of the housing 21 being formed with a large radius of curvature and having a rounded shape.

Furthermore, since the rear end part of the rear housing 23 forming the rear part of the housing 21 includes the inclined face 23a tapered to the rear, and the vertical fin 19 of the defroster blower outlet 17 is directed at part of the inclined face 23a on the laterally outer wall 21b side of the housing 21 when viewed from above (see arrow B in FIG. 3), air directed further toward the laterally outer side than said part of the inclined face 23a impinges on the front part of the side window screen 14, and air directed further toward the laterally inner side than said part of the inclined face 23a impinges on the rear part of the side window screen 14, thus enabling the entire region of the side window screen 14 to be demisted effectively.

Moreover, since the radius of curvature of the first corner portion 21c at the laterally outer end of the upper wall 21 a of the housing 21 is larger than the radius of curvature of the second corner portion 21d at the rear end of the upper face of the housing 21, in the first corner portion 21c the warm air can be deflected smoothly downward to thus demist the lower front part of the side window screen 14 effectively, warm air directed at the rear end of the upper wall 21a of the housing 21 is made to separate by means of the second corner portion 21d with a small radius of curvature and is made to fly a long way toward the rear from the housing 21, thus enabling the rear part of the side window screen 14 to be demisted effectively.

An embodiment of the present invention is explained above, but the present invention may be modified in a variety of ways as long as the modifications do not depart from the gist of the present invention.

For example, the number of vertical fins 19 in the embodiment is one, but there may be a plurality of the vertical fins 19.

What is claimed is:

1. A side defroster device comprising
a front pillar that rises from a laterally outer end part of an instrument panel, and
a defroster blower outlet that is provided in the front pillar and blows out air toward a side window screen,
wherein a display device that displays an image of a vehicle exterior is provided on the instrument panel to a rear of the front pillar, and
the defroster blower outlet is positioned so as to overlap, in a vehicle width direction, an upper wall of a housing when viewed in a fore-and-aft direction.

2. The side defroster device according to claim 1, wherein the lower end of the defroster blower outlet is positioned so as to be in contact with the upper wall of the housing.

3. The side defroster device according to claim 1, wherein
a side door is disposed on a laterally outer side of the instrument panel,
the housing protrudes from the instrument panel to the laterally outer side, and
a position in an up-down direction of an upper end of a door lining covering a laterally inner face of the side door is present between an upper end and a lower end of the housing.

4. The side defroster device according to claim 2, wherein
a side door is disposed on a laterally outer side of the instrument panel,
the housing protrudes from the instrument panel to the laterally outer side, and
a position in an up-down direction of an upper end of a door lining covering a laterally inner face of the side door is present between an upper end and a lower end of the housing.

5. The side defroster device according to claim 1, wherein a corner portion between the upper wall and a laterally outer wall of the housing has a rounded shape.

6. The side defroster device according to claim 2, wherein a corner portion between the upper wall and a laterally outer wall of the housing has a rounded shape.

7. The side defroster device according to claim 3, wherein a corner portion between the upper wall and a laterally outer wall of the housing has a rounded shape.

8. The side defroster device according to claim 4, wherein a corner portion between the upper wall and a laterally outer wall of the housing has a rounded shape.
